(19) United States
(12) Patent Application Publication
(10) Pub. No.: US 2026/0347041 A1
(43) Pub. Date: Nov. 5, 2026

(54) FOOD OR BEVERAGE COLLAPSIBLE CONTAINER

(71) Applicant: Mitali Pamela ATKINS, Bath (GB)

(72) Inventor: Mitali Pamela ATKINS, Bath (GB)

(21) Appl. No.: 19/486,959

(22) PCT Filed: Jun. 7, 2024
(86) PCT No.: PCT/GB2024/051474

§ 371 Date: Nov. 24, 2025

(30) Foreign Application Priority Data
Jun. 12, 2023 (GB) 2308741.4

(51) Int. Cl. B65D 1/02; B31B 50/59; B65D 23/02; B65D 65/46

(52) U.S. Cl. CPC B65D 1/0292; B31B 50/59; B65D 23/02; B65D 65/466; B65D 2501/0054

(57) ABSTRACT

The present invention relates to a collapsible, disposable food or beverage container. The container comprises a housing comprising: a first end comprising a top portion defining an outlet; an opposed second end comprising a base portion; and side portions extending between the first and second ends. A cavity for receiving a food or beverage is defined between the first end, second end and side portions of the housing, and in which the cavity is in fluid communication with the outlet. A longitudinal axis is defined between the first and second ends of the housing. The container is moveable in a direction between: a first collapsed configuration in which an end or side portion is located at or adjacent a respective opposed end or opposed side portion; and a second expanded configuration in which the end or side portion is spaced apart from the respective opposed end or opposed side portion of the housing to provide the cavity. The housing is formed entirely from paper material, and in which the entire container is home compostable and/or biodegradable.

The present invention relates to a collapsible, disposable food or beverage container. The present invention also relates to a method for the manufacture of a collapsible, disposable food or beverage container.

### BACKGROUND OF INVENTION

Up to three meals may be served to passengers during the duration of a long haul flight. Each meal provides a plastic bottle or an aluminium covered plastic cup of water for each passenger. On a typical aircraft, such as for example the Boeing 777-300, 388 passengers receive three bottles/cups of water during the flight. This equates to 1164 bottles/cups being used within a single flight. There are thousands of long haul flights operating each day across the world. Most of the cabin waste is not recycled as it is not segregated. Therefore, 1164 bottles/cups per long haul flight are sent to landfill. It is known that plastic bottles take around 450 years to decompose in landfill. The aviation industry therefore produces a significant amount of waste.

Passengers should be consuming more water during a flight than they would normally consume due to dry air and altitude. In order to board a plane, users are however required to empty liquid containers as these are not allowed through security. As a result, users are often boarding planes without access to water other than the water being offered with a meal.

There is therefore a need to encourage passengers to drink more water once onboard a flight whilst also reducing the associated waste being sent to landfill.

### SUMMARY OF INVENTION

According to a first aspect of the present invention, there is provided a collapsible, disposable food or beverage container comprising:
a housing comprising:
   a first end comprising a top portion defining an outlet;
   an opposed second end comprising a base portion; and
   side portions extending between the first and second ends,
   in which a cavity for receiving a food or beverage is defined between the first end, second end and side portions of the housing, and in which the cavity is in fluid communication with the outlet, and
   in which a longitudinal axis is defined between the first and second ends of the housing;
   and in which the container is moveable in a direction between:
      a first collapsed configuration in which an end or side portion is located at or adjacent a respective opposed end or opposed side portion; and
      a second expanded configuration in which the end or side portion is spaced apart from the respective opposed end or opposed side portion of the housing to provide the cavity;
         in which the housing is formed entirely from paper material, and in which the entire container is home compostable and/or biodegradable.

The container of the present invention is capable of being collapsed (i.e. placed in the first collapsed configuration) when not in use. Preferably, the container is capable to being collapsed to less than half of its original size. For example, the container is preferably able to be collapsed to at least half of its original length (i. e its length in the second expanded configuration) when measured between opposed end portions. In one embodiment, the container may be able to be collapsed to at least half of its original width (i.e. its width in the second expanded configuration) when measured between opposed side portions.

By being able to be placed in a collapsed configuration, the user is able to carry the container easily through for example security to satisfy local and international regulations relevant to airport security measures. Furthermore, the containers can be stored and transported on a vehicle without requiring a large amount of storage space. For example, larger numbers of containers, for a given space, can be transported from a factory or distribution centre to for example an airport. This reduces transportation costs and associated time and environmental considerations.

Once through security, the user may move the container to the second expanded configuration and fill the container (with for example water) prior to boarding the flight. By carrying a container onto the flight with water, the user will be encouraged to drink more water, and more regularly, during the flight.

Transportation of the container is easier in the collapsed configuration, which again encourages the user to empty the container whilst on the flight.

The user may adjust the dimensions of the container (as measured between opposed surfaces; for example the length of the container as measured between opposed ends of the housing) in accordance with the volume of fluid present within the cavity of the housing.

The container of the present invention may replace plastic containers. The container of the present invention is preferably 100% recyclable, or 100% biodegradable, or 100% home compostable. Therefore, the container of the present invention does not contribute to landfill waste providing for a significant waste saving on every long haul flight.

The term “home compostable” is used herein to refer to a container which is capable of breaking down or fully decomposing through biological processes or conditions, within for example a home compost bin, into natural elements without generating any toxic byproducts, within a predefined period such as 90 days

The term “biodegradable” is used herein to refer to a container which is able to decay naturally in a way that is not harmful and does not produce any toxic byproducts.

The container of the present invention is preferably entirely formed from paper material.

The paper material may be card or paper, or a mixture thereof. For example, the paper material may comprise Kraft card or unbleached paper. The paper material may be recycled paper material.

Preferably the paper material has a weight of no more than 200 gsm. Preferably, the paper material has a weight of at least 100 gsm. In one embodiment, the paper material has a weight of approximately 130/140 gsm.

The housing preferably comprises at least one line of weakness configured to enable movement between the first collapsed configuration and the second expanded configuration. The at least one line of weakness may comprise one or more folds.

In one embodiment, the container is moveable in a direction extending parallel to the longitudinal axis of the housing, between:
a first collapsed configuration in which the first end is located at or adjacent the second end of the housing; and
a second expanded configuration in which the first end is spaced apart from the second end of the housing to provide the cavity.

In one embodiment, the container is moveable in a direction extending substantially perpendicular to the longitudinal axis of the housing, between:
a first collapsed configuration in which a first side portion is located at or adjacent a second opposed side portion of the housing; and
a second expanded configuration in which the first side portion is spaced apart from the second opposed side portion of the housing to provide the cavity.

The container may be configured in use to be moveable between the first collapsed configuration and the second expanded configuration by rotation of the first end relative to the second end. For example, the container is configured in use such that the first end is rotatable relative to the second end about the longitudinal axis of the housing.

Preferably, opposed ends of a single sheet of paper material are affixed together to provide the housing defining the cavity. The opposed ends are preferably provided by the same sheet of paper material.

An inner surface of the housing formed from the paper material may be coated with a water resistant coating. The water resistant coating may for example be wax, preferably candle wax or beeswax.

In one embodiment, the container further comprises an inner lining located within the cavity of the housing. The inner lining may be configured to receive food or beverage. The inner lining may be composed of plastic material. The inner lining is preferably biodegradable or recyclable.

Preferably, the inner lining is composed of one or more of: seaweed plastic, natural plant latex and/or PLA layer.

The inner lining may be configured for releasable engagement with the housing. The inner lining may be attached to at least a portion of an inner surface of the housing. For example, the inner lining is attached to at least a portion of an inner surface of a side portion and/or ends of the housing.

The housing preferably comprises at least one longitudinal fold extending predominantly between the first and second ends thereof. Preferably, the housing comprises a plurality of uniformly spaced longitudinal folds extending predominantly between the first and second ends thereof.

The housing preferably comprises at least one lateral fold extending in a direction substantially perpendicular to the longitudinal axis of the housing. The housing preferably comprises a plurality of uniformly spaced lateral folds extending in a direction substantially parallel to the longitudinal axis of the housing.

In one embodiment, the container comprises:
a plurality of uniformly spaced longitudinal folds extending predominantly between the first and second ends thereof;
a plurality of uniformly spaced lateral folds extending in a direction substantially parallel to the longitudinal axis of the housing; and
at least one, preferably a plurality of uniformly spaced, diagonal folds extending at an angle to the longitudinal folds and lateral folds.

The housing preferably comprises at least one mountain fold (i.e. a fold which produces a ridge) and at least one valley fold (i.e. a fold which produces a trench).

Preferably, at least one of the longitudinal, lateral and diagonal folds is a mountain fold, and in which at least one of the longitudinal, lateral and diagonal folds is a valley fold.

In one embodiment, the container comprises:
a plurality of uniformly spaced longitudinal folds extending predominantly between the first and second ends thereof;
a plurality of uniformly spaced lateral folds extending in a direction substantially parallel to the longitudinal axis of the housing; and
at least one, preferably a plurality of uniformly spaced, diagonal folds extending at an angle to the longitudinal folds and lateral folds,
in which the longitudinal folds are mountain folds, in which the lateral folds are mountain folds, and in which the diagonal folds are valley folds.

In one embodiment, the container comprises:
a plurality of uniformly spaced longitudinal folds extending predominantly between the first and second ends thereof;
a plurality of uniformly spaced lateral folds extending in a direction substantially parallel to the longitudinal axis of the housing; and
at least one, preferably a plurality of uniformly spaced, diagonal folds extending at an angle to the longitudinal folds and lateral folds,
in which the longitudinal folds are mountain folds, in which the lateral folds are valley folds, and in which the diagonal folds are mountain folds.

The housing preferably has a polygonal transverse cross-section. For example, the housing may have a decagon transverse cross-section.

The housing may comprise a body portion, a top portion and a base portion.

The top portion and/or base portion are preferably attached to the side portions of the body portion of the housing by heat sealing.

Preferably, the top portion comprises a neck portion (for example bottle neck portion) or spout portion or nozzle portion defining the outlet, in which the neck portion or spout portion or nozzle portion is formed from paper pulp material.

The top portion preferably comprises a contact surface from which the neck portion or spout portion or nozzle portion extends upwardly therefrom.

The neck portion or spout portion or nozzle portion preferably has a first end located adjacent the contact surface of the top portion and an opposed second free end.

The neck portion or spout portion or nozzle portion preferably defines an outlet at the second free end thereof and a fluid passageway extending from the outlet towards the first end thereof and configured in use to be in fluid communication with the cavity of the housing.

In one embodiment, the contact surface defines the outlet. The outlet may be positioned at or adjacent the spout portion or neck portion or nozzle portion. The neck portion or nozzle portion or spout portion preferably defines a fluid pathway for directing fluid exiting the outlet towards a mouth of a user during use. The nozzle portion or spout portion preferably comprises a raised lip portion configured in use to direct fluid from the outlet and towards the mouth of a user. The lip portion preferably extends around at least a portion of the periphery of the contact surface. In one embodiment, the lip portion extends around the entire periphery of the contact surface.

The neck portion or nozzle portion or spout portion may have a height, as measured from the first end to the second free end thereof. The height of the neck portion or nozzle portion or spout portion may vary along the periphery of the contact surface depending on the requirements for the container.

The container may also further comprise a fastener to retain the container in the first collapsed configuration. The container may be retained within the first collapsed configuration using a fastener in the form of a strap which is configured to extend between the first and second ends of the container and to prevent unintentional movement of the container towards the second expanded position (for example movement of the first end away from the second end).

The fastener is preferably composed of paper material. The fastener is preferably entirely composed of paper material.

The fastener is preferably movable between a first position, when the container is in the first collapsed configuration, in which the fastener prevents unintentional movement of the container towards the second expanded configuration, and a second position in which the fastener is secured to at least a portion of the housing enabling a user to utilise the fastener for transportation of the container.

In one embodiment, at least one end (preferably both ends of the fastener, are secured at or adjacent the nozzle portion of the housing.

Preferably the fastener, in the second position, defines a handle portion located at or adjacent the top portion of the housing for receiving a hand of a user. Preferably the fastener, in the first position, is configured in use to extend substantially entirely around the housing in the first collapsed configuration. The fastener may for example be moveable between the first and second position by rotation.

The container may further comprise a tear off portion configured in use to enable a user to easily open the container (for example housing). In particular, the container may comprise a tear off portion enabling a user to access an inner surface of the housing. For example, the tear off portion may enable a user to access an inner surface of the housing (for example body of the housing) so that the user can remove an inner lining from the paper material of the housing. As such, the user can separate the components of the container and recycle these components (i.e. the paper material of the housing and the waterproof inner lining) separately.

The tear off portion may be provided by one or more lines of weakness, for example one or more lines of perforations.

The tear off portion may comprise a tab portion configured to enable a user to separate the tear off portion from the rest of the container.

The tear off portion may be located on any suitable portion of the container. The tear off portion may be located at or adjacent an end of the container, for example at or adjacent an end of the housing (for example at or adjacent an end of the body of the housing).

The container may comprise one or more: logos, designs, and/or text on an outer surface of the container.

The container may be configured to enable a third party to see how much fluid or food is stored within the container. For example, the container may be composed of one or more transparent or translucent portions.

The container may comprise an identification tag, for example a QR code. The identification tag may enable a user or third party to monitor the usage of the container, for example the number of times the container has been refilled, the frequency at which the container has been refilled, and/or the locations of refill.

According to a further aspect of the present invention, there is provided a method for the manufacture of a collapsible, disposable food or beverage container, comprising:
obtaining a mould configured to provide housing having predetermined shape, dimensions and one or more lines of weaknesses;
obtaining paper material and positioning over the mould;
applying a force to compress the paper material onto the mould to provide resultant housing having the predetermined shape, dimensions and one or more lines of weaknesses.

Preferably, the housing is formed from a single sheet of paper material.

Preferably, the mould has one or more ridges and/or indentations at predetermined locations. Each ridge and/or indentation is preferably configured to provide a corresponding mountain or valley fold on the paper material.

The method preferably further comprises coating an inner surface of the paper material with a water resistant coating prior to positioning over the mould.

In one embodiment, the method further comprises securing opposed ends of the paper material to define a tubular material prior to positioning over the mould.

Preferably, the method further comprises attaching a top portion and a base portion to opposed ends of the housing. The top portion and base portion may be attached by heat sealing.

Preferably, the method further comprises forming a neck portion or nozzle portion or spout portion defining an outlet from paper pulp.

The method may further comprise attaching a neck portion or spout portion or nozzle portion to the top portion of the housing.

Embodiments of the present invention will now be described in relation to the accompanying figures:

### BRIEF DESCRIPTION OF FIGURES

FIGS. 1A to 1D are schematic illustrations of various embodiments of the container of the present invention being moved from the first collapsed configuration to the second expanded configuration;

FIG. 2 is a schematic illustration of the paper material (with folds) used to form the container according to one embodiment of the present invention;

FIG. 3 is a schematic illustration of the paper material (with folds) used to form the container according to a further embodiment of the present invention;

FIG. 4 is a schematic illustration of paper material (with folds) for use in forming a container according to a further embodiment of the present invention;

FIGS. 5A and 5B are photographs of the container according to one embodiment of the present invention in the second expanded configuration and the first collapsed configuration;

FIGS. 6A and 6B are schematic illustrations of a top portion and a base portion for a container according to one embodiment of the present invention;

FIGS. 7A and 7B are schematic illustrations of a container according to one embodiment of the present invention with the top portion and base portion of FIGS. 6A and 6B;

FIG. 8 is a schematic illustration of a bottle neck of a container according to one embodiment of the present invention;

FIG. 9 is a schematic illustration of an exploded view of a container according to one embodiment of the present invention;

FIG. 10 is a schematic illustration of a method for manufacturing the housing of a container according to one embodiment of the present invention;

FIG. 11 is a schematic illustration of a method for manufacturing a base portion of a container according to one embodiment of the present invention;

FIG. 12 is a schematic illustration of a method of manufacturing a bottle neck of a container according to one embodiment of the present invention;

FIG. 13 is a schematic illustration of a method of manufacturing a top portion of a container according to one embodiment of the present invention;

FIG. 14 is a schematic illustration of a method of manufacturing a container according to one embodiment of the present invention; and

FIG. 15 is a schematic illustration of a container according to one embodiment of the present invention in use.

### DETAILED DESCRIPTION

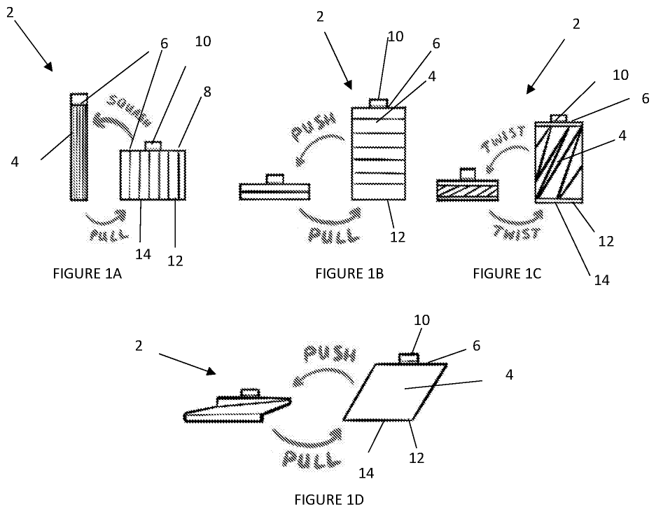

With reference to FIGS. 1A-1D, the collapsible, disposable food or beverage container 2 comprises a housing 4 comprising a first end 6 comprising a top portion 8 defining an outlet 10 and an opposed second end 12 comprising a base portion 14. Side portions 16a, b extend between the first 6 and second 12 ends. A cavity (not shown) for receiving a food or beverage is defined between the first end 6, second end 12 and side portions 16a, b of the housing 4. The cavity is in fluid communication with the outlet 10. A longitudinal axis is defined between the first 6 and second ends 12 of the housing 4. The container 2 is moveable in a direction between: a first collapsed configuration in which an end 6, 12 or side portion 16a, b is located at or adjacent a respective opposed end 12, 6 or opposed side portion 16a, b; and a second expanded configuration in which the end 6, 12 or side portion 16a, b is spaced apart from the respective opposed end 12, 6 or opposed side portion 16a, b of the housing 4 to provide the cavity. The housing 4 is formed from paper material.

As shown in FIG. 1A, the container 2 may be moved between the first collapsed configuration and second expanded configuration by moving (for example pulling) the side portions 16a, b in a direction away from each other. The container 2 is configured to expand and contract in a direction extending substantially perpendicular to the longitudinal axis.

As shown in FIG. 1B, the container 2 may be moved between the first collapsed configuration and second expanded configuration by moving (for example pulling) the opposed ends 6, 12 in a direction away from each other. The container 2 is configured to expand and contract in a direction extending substantially parallel to the longitudinal axis.

As shown in FIG. 1C, the container 2 may be moved between the first collapsed configuration and second expanded configuration by rotating the opposed ends 6, 12 relative to each other. Rotation of the ends 6, 12 relative to each other causes the container 2 to expand and contract in a direction extending substantially parallel to the longitudinal axis.

As shown in FIG. 1D, the container 2 may be moved between the first collapsed configuration and second expanded configuration by moving (for example pulling) the opposed ends 6, 12 in a direction away from each other. The container 2 is configured to expand and contract in a direction extending substantially parallel to the longitudinal axis.

The container 2 is capable to being collapsed less than half of its original size. For example, the container is capable of being collapsed to less than half of its original length (i. e the term “original length” herein refers to the length of the container when in the second expanded configuration) when measured between opposed end portions 6, 12 (FIGS. 1B-1D). As shown in FIG. 1A, the container 2 is able to be collapsed to at least half of its original width (i.e. the term “original width” is used herein to refer to the width of the container when in the second expanded configuration) when measured between opposed side portions 16a, b.

The body of the housing 4 is formed entirely from paper material. In the illustrated embodiment, the body of the housing 4 is formed from paper. It is however to be understood that the body of the housing 4 may be formed from card, paper or a mixture thereof.

The paper used to form the housing has a weight of approximately 130/140 gsm. It is however to be understood that the paper material may have a weight of at least 100 gsm and preferably no more than 200 gsm.

In the illustrated embodiments, opposed ends of a single sheet of paper are affixed together to provide the body of the housing 4 defining the cavity.

An inner surface of the housing formed from the paper material may be coated with a water resistant coating. The water resistant coating may for example be wax, preferably candle wax or beeswax.

The housing 4 (for example the body of the housing) comprises a plurality of lines of weakness configured to enable movement between the first collapsed configuration and the second expanded configuration. The lines of weakness are one or more folds.

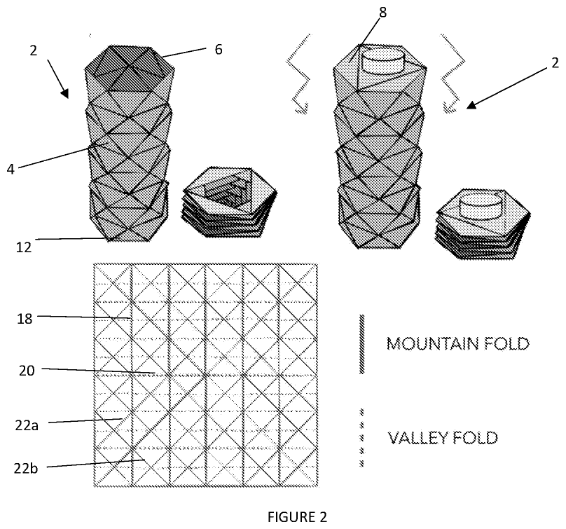

As shown in FIG. 2, the container 2 comprises a body of a housing 4 is formed from a single piece of paper. The body of the housing 4 has a plurality of longitudinal folds 18 extending predominantly between the first 6 and second 12 ends thereof. The longitudinal folds 18 are uniformly spaced apart from each other. It is however to be understood that in some embodiments, the longitudinal folds 18 may be unevenly spaced apart from each other.

The body of the housing 4 also comprises a plurality of uniformly spaced lateral folds 20 extending in a direction substantially perpendicular to the longitudinal axis of the housing 4. It is however to be understood that in some embodiments, the lateral folds 20 may be unevenly spaced apart from each other.

The body of the housing 4 also comprise a first set of uniformly spaced diagonal folds 22a extending at an angle to the lateral folds 20 and the longitudinal folds 18. The body of the housing 4 further comprises a second set of uniformly spaced diagonal folds 22b extending at an angle to the lateral folds 20 and longitudinal folds 18 and intersecting the first set of diagonal folds 22a. It is however to be understood that in some embodiments, the diagonal folds 22a, 22b may be unevenly spaced apart from each other. It is also to be understood that in some embodiments, the body of the housing 4 may comprise a single set of diagonal folds 22a, b (or no diagonal folds).

The longitudinal folds 18 and the first and second sets of diagonal folds 22a, b are mountain folds (i.e. folds which create a ridge protruding from an outer surface of the paper material). The lateral folds 20 are valley folds (i.e. folds which create a trench on the outer surface of the paper material).

Opposing ends of the paper are adjoined together to form a tubular shaped body of the housing 4.

In use, as shown in FIG. 2, application of a force to the first end 6 of the body of the housing 4 causes the housing to contract in a direction extending substantially parallel to the longitudinal axis to be placed in the first collapsed configuration which is less than half of the length of the original container 2.

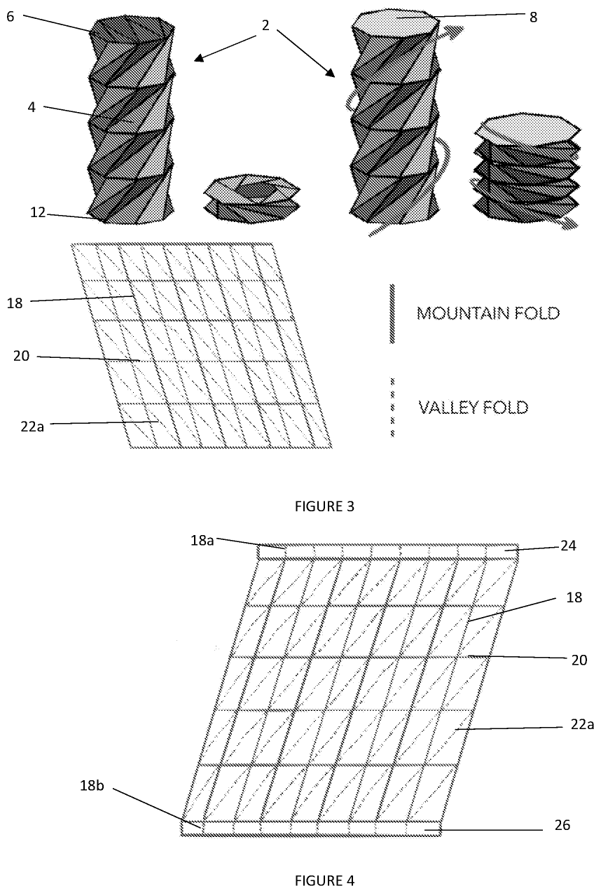

As shown in FIG. 3, the container 2 comprises a body of the housing 4 formed from a single piece of paper. The body of the housing 4 has a plurality of longitudinal folds 18 extending predominantly between the first 6 and second 12 ends thereof. The longitudinal folds 18 are uniformly spaced apart from each other. It is however to be understood that in some embodiments, the longitudinal folds 18 may be unevenly spaced apart from each other.

The body of the housing 4 also comprises a plurality of uniformly spaced lateral folds 20 extending in a direction substantially perpendicular to the longitudinal axis of the housing 4. It is however to be understood that in some embodiments, the lateral folds 20 may be unevenly spaced apart from each other.

The body of the housing 4 also comprise a set of uniformly spaced diagonal folds 22 extending at an angle to the lateral folds 20 and the longitudinal folds 18. It is however to be understood that in some embodiments, the diagonal folds 22 may be unevenly spaced apart from each other.

The longitudinal folds 18 and the lateral folds 20 are mountain folds (i.e. folds which create a ridge protruding from an outer surface of the paper material). The diagonal fold 22 is a valley fold (i.e. folds which create a trench on the outer surface of the paper material).

Opposing ends of the paper are adjoined together to form a tubular shaped body of the housing 4.

In use, as shown in FIG. 3, application of a rotational force causes the first end 6 of the body of the housing 4 to rotate relative to the second end 12 causing the housing to contract in a direction extending substantially parallel to the longitudinal axis to be placed in the first collapsed configuration which is less than half of the length of the original container 2.

The paper material may be provided in any suitable shape. In FIG. 2, it can be seen that the paper is rectangular in shape. In FIG. 3, it can be seen that the paper is in the shape of a rhombus. It is to be understood that the paper material may be in any suitable polygonal shape.

As shown in FIG. 4, the container 4 is formed from a single piece of paper in a similar manner to FIG. 3. The body of the housing 4 comprises a plurality of longitudinal folds 18 extending predominantly between the first 6 and second 12 ends thereof. The longitudinal folds 18 are uniformly spaced apart from each other. It is however to be understood that in some embodiments, the longitudinal folds 18 may be unevenly spaced apart from each other.

The body of the housing 4 also comprises a plurality of uniformly spaced lateral folds 20 extending in a direction substantially perpendicular to the longitudinal axis of the housing 4.

It is however to be understood that in some embodiments, the lateral folds 20 may be unevenly spaced apart from each other.

The body of the housing 4 also comprise a set of uniformly spaced diagonal folds 22 extending at an angle to the lateral folds 20 and the longitudinal folds 18. It is however to be understood that in some embodiments, the diagonal folds 22 may be unevenly spaced apart from each other.

The longitudinal folds 18 and the lateral folds 20 are mountain folds (i.e. folds which create a ridge protruding from an outer surface of the paper material). The diagonal fold 22 is a valley fold (i.e. folds which create a trench on the outer surface of the paper material).

The housing 4 also comprises an additional top portion 24 at the first end 6, and an additional base portion 26 at the second end 12. The top portion 24 and base portion 26 comprise additional longitudinal folds 28a, b aligned with the longitudinal folds 18. The longitudinal folds 18a, b of the top portion 24 and base portion 26 are however valley folds.

Opposing ends of the paper are adjoined together to form a tubular shaped housing 4.

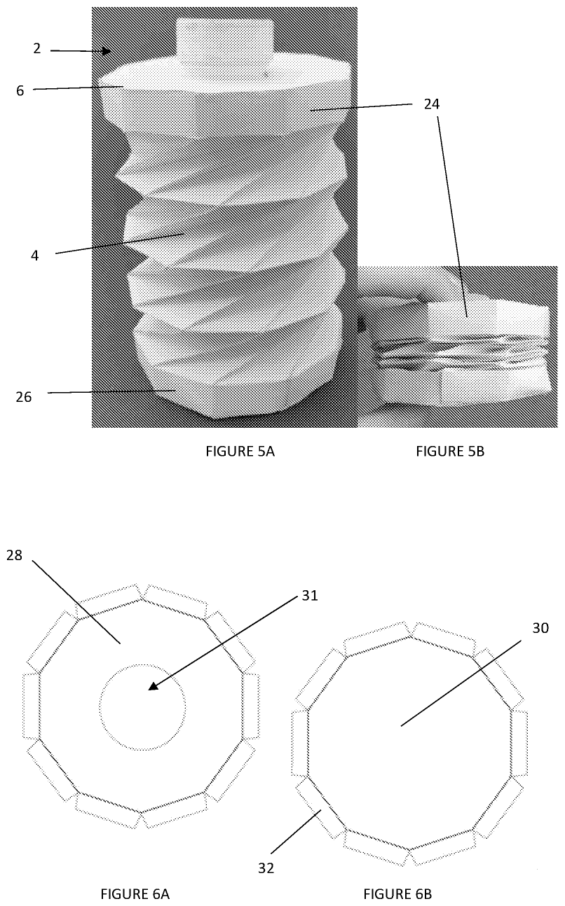

The container 2 formed from the housing 4 of FIG. 4 is shown in FIG. 5. The container 2 has a rigid top portion 24 and base portion 26 providing for improved strength and rigidity of the container 2. On application of a compressive force (as shown in FIG. 5B), the container 2 is moved to the first, collapsed position with a length which is less than half of the length of the container in the second expanded position (FIG. 5A).

As shown in FIG. 6A, the container 2 may further comprise a top portion 28 in the form of a planar member with a polygonal cross-section. The top portion 28 has tab portions 32 extending outwardly from each edge of the polygon. In the illustrated embodiment, the top portion 28 is has a decagon shape. It is however to be understood that the top portion 28 may have any suitable shape. The shape of the top portion 28 preferably corresponds to the cross-section of the adjoining portion of the housing 4. The top portion 28 is configured in use to be positioned and to extend between opposing side portions 16a, b of the body of the housing 4 (i.e. to substantially seal an end of the body of the housing 4). In the illustrated embodiment, the top portion 28 is configured to extend substantially perpendicular to the longitudinal axis of the housing 4. It is however to be understood that the top portion 28 may not be planar and/or may extend at any suitable angle relative to the longitudinal axis of the housing 4. The tab portions of the top portion 28 are configured in use to attach to corresponding portions of the body of the housing 4. The top portion 28 provides an opening 31. The opening 31 may provide an outlet for the container 2 or may be shaped and dimensioned to receive a bottle neck (not shown).

As shown in FIG. 6B, the container 2 may further comprise a base portion 30 in the form of a planar member with a polygonal cross-section. The base portion 30 has tab portions extending outwardly from each edge of the polygon. In the illustrated embodiment, the base portion 30 is has a decagon shape. It is however to be understood that the base portion 30 may have any suitable shape. The shape of the base portion 30 preferably corresponds to the cross-section of the adjoining portion of the housing 4. The base portion 30 is configured in use to be positioned and to extend between opposing side portions 16a, b of the bod of the housing 4 (i.e. to substantially seal an end of the body of the housing 4). In the illustrated embodiment, the base portion 30 is configured to extend substantially perpendicular to the longitudinal axis of the housing 4. It is however to be understood that the base portion 30 may not be planar and/or may extend at any suitable angle relative to the longitudinal axis of the housing 4. The tab portions of the base portion 30 are configured in use to attach to corresponding portions of the body of the housing 4.

The top portion 28 and base portion 30 may be composed of the same material or different materials. The top portion 28, base portion 30 and housing 4 may be composed of the same material or different materials. The top portion 28, base portion 30 and housing 4 are composed of paper material, for example cardboard and/or paper (for example recycled cardboard and/or paper). The paper material may be Kraft paper and/or unbleached paper.

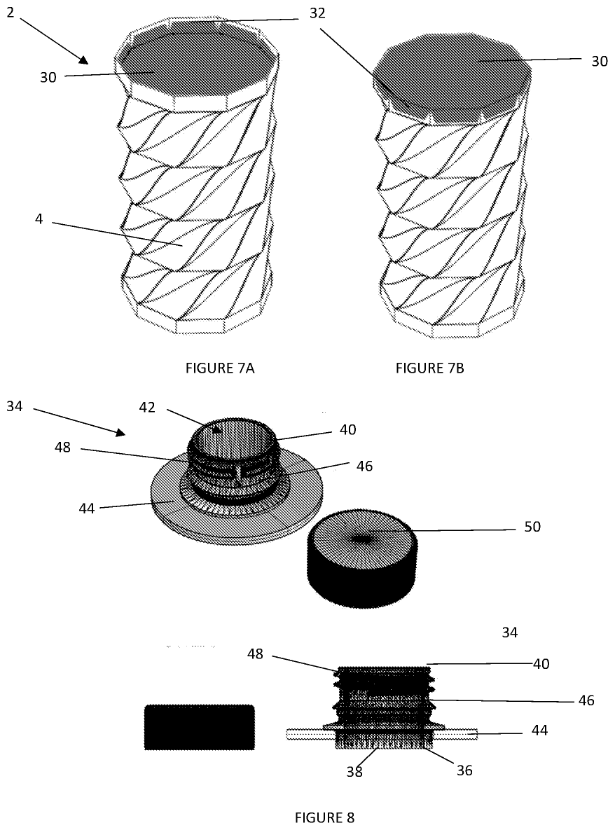

As shown in FIGS. 7A and 7B, the top portion 28 or base portion 30 (i.e. the tab portions of the top portion 28 or base portion 30) may be heat sealed to the body of the housing 4. The top portion 28 or base portion 30 may be heat sealed to an inner surface of the body of the housing 4 (FIG. 7A) or to an outer surface of the body of the housing 4 (FIG. 7B). The top portion 28 or base portion 30 may be affixed to the body of the housing by any suitable means, including for example using an adhesive.

The inner surfaces of the housing 4, the top portion 28 and the base portion 30 are prewaxed (for example with beeswax or candlewax) prior to forming the housing. In some embodiments, the container 2 may further comprise an inner liner located within the cavity (not shown) of the housing 4. The inner liner is waterproof. The inner liner may be attached to an inner surface of one or more of the housing 4 and/or top portion 28.

The top portion 28 of the container 2 provides an opening 30 for a bottle neck 34 as shown in FIG. 8. The bottle neck 34 comprises a first end 36 providing an inlet 38 and a second opposed end 40 providing an outlet 42 and a channel (not shown)extending therebetween. The bottle neck 34 further comprises a outwardly extending flange 44 located at or adjacent the first end 36 and extending from an outer surface 46 of the bottle neck 34. The flange 44 is substantially circular in cross section. The second opposed end 40 comprises a threaded portion 48 on the outer surface 46 thereof. The container 2 further comprises a lid 50 comprising a threaded portion (not shown) configured for cooperative engagement with the threaded portion 48 of the bottle neck 34. It is to be understood that the lid container may include any suitable lid or cap configured for releasable engagement with the neck and is not limited to the use of complimentary threaded portions.

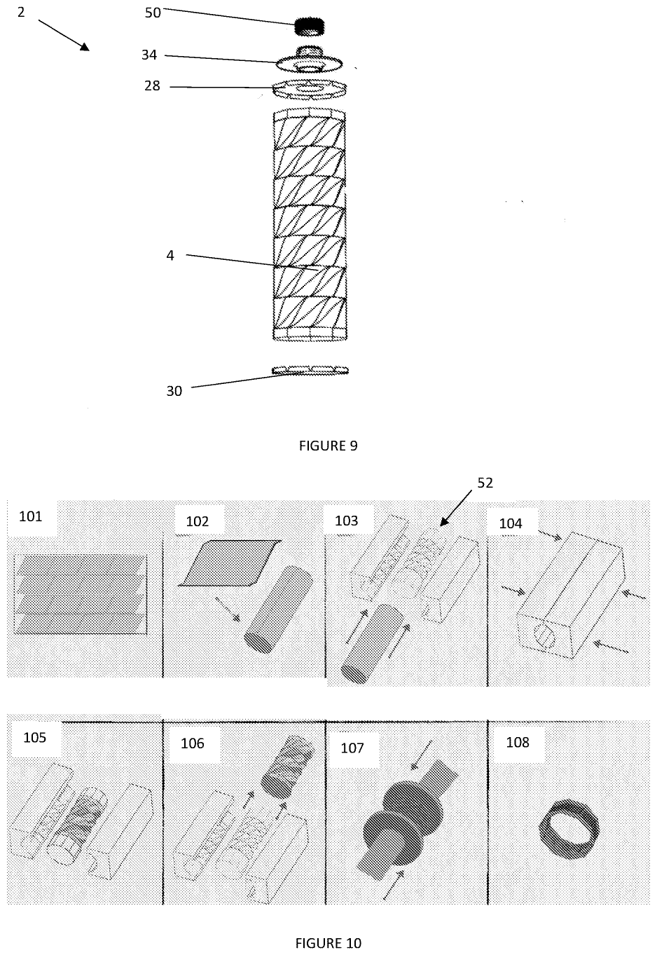

The base portion 30, top portion 28 and bottle neck 34 are connected to the housing 4 as shown in FIG. 9.

The first end 36 is received within the opening 30 of the top portion 28. An inner surface (not shown) of the top portion 28 abuts the flange 44 adjacent the first end 36 of the bottle neck 34. The channel 42 of the bottle neck 34 is in fluid communication with the cavity (not shown) of the housing 4.

The bottle neck 34 is formed from paper pulp material.

The container 2 of the present invention is collapsible and disposable. The container 2 of the present invention is composed of 100% biodegradable or recyclable material.

As shown in FIG. 10, the collapsible, disposable food or beverage container is formed from a single sheet of paper material. The paper material is provided as a roll of precoated paper material. The paper material is precoated with any suitable waterproof coating such as for example wax (e.g. beeswax). The roll of paper material is cut into a suitable, predetermined tessellating pattern comprising a plurality of closely fitting shapes (e.g. polygonal shapes such as rhombus shapes or rectangles) with minimal gaps therebetween (Step 101). A single cut shape of paper material is then arranged such that opposed edges of the shape are secured together by the use of adhesive (Step 102) to provide a tubular shaped body of the housing 4. The body of the housing 4 is inserted into a mould 52 configured to shape the body of the housing 4 so as to have predetermined shape, dimensions and one or more lines of weaknesses (i.e. folds) (Step 103). The mould 52 is then operated to apply a force to compress the paper material onto the mould 52 to provide resultant housing having the predetermined shape, dimensions and one or more lines of weaknesses (Step 104). On completion of the compressing stage, the mould 52 is opened (Step 105) and the body of the housing 4 is removed (Step 106). A further compressive force is subsequently applied, in a direction extending substantially parallel to the longitudinal axis of the body of the housing 4 (Step 107) to provide the housing 4 in the first collapsed configuration (Step 108).

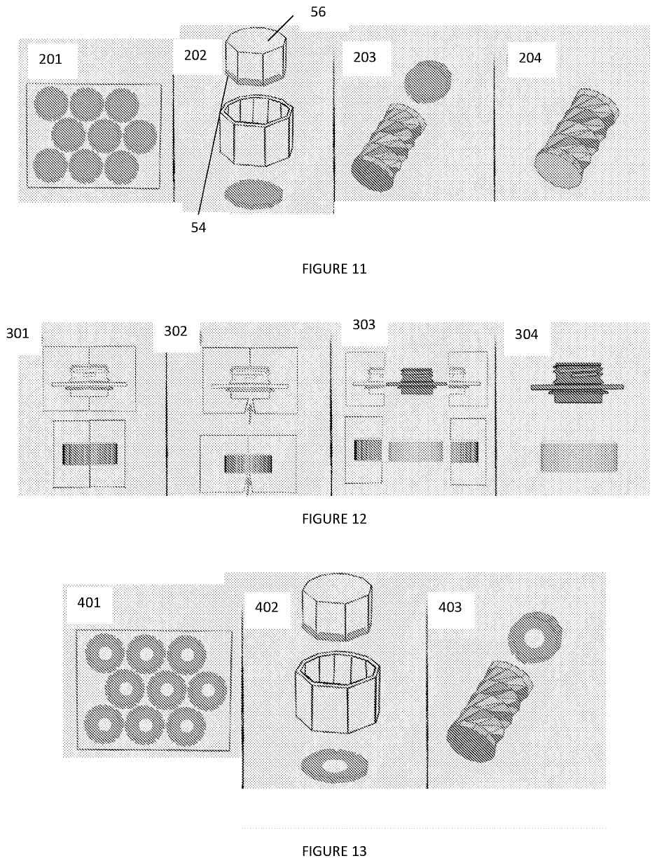

As shown in FIG. 11, a roll of paper material is provided and blanks are cut into a tessellating pattern comprising a plurality of base portions 30 in the shape of polygons, such as for example decagons (Step 201). Each base portion 30 comprises a plurality of tab portions 54, each tab portion extending outwardly from an edge of the polygon. The tab portion 54 is configured for attachment to a respective portion of the body of the housing 4.

Each base portion 30 is then folded using a mould 56 to ensure that the tab portions 54 are extending upwardly from the plane defined by the base portion (Step 202).

The base portion 30 is aligned with an end of a body of the housing 4 formed by the process illustrated in FIG. 10. The tab portions 54 are heat sealed to corresponding portions of the housing 4 (Step 203).

As shown in FIG. 12, a mould 58 for a bottle neck 34 and lid 50 is provided (Step 301). Pulp material made from paper and hot water is introduced into the mould 58 (Step 302). The mould 58 is released and the formed bottle neck 34 and lid 50 are dried, for example oven dried (Step 303) to form the bottle neck 34 and lid 50.

FIG. 13 illustrates the method of manufacturing a top portion 28 of the container 2. A roll of paper material is provided and blanks are cut into a tessellating pattern comprising a plurality of top portions 28 in the shape of polygons, such as for example decagons (Step 401).

Each top portion 28 comprises a plurality of tab portions 32, each tab portion extending outwardly from an edge of the polygon. The tab portion 32 is configured for attachment to a respective portion of the body of the housing 4.

Each top portion 28 is then folded using a mould 60 to ensure that the tab portions 32 are extending upwardly from the plane defined by the top portion 28 (Step 402).

The top portion 28 is aligned with an end of a body of the housing 4 formed by the process illustrated in FIG. 10. The tab portions 32 are heat sealed to corresponding portions of the housing 4 (Step 403).

As shown in FIG. 14, the container 2 is assembled by heat sealing the base portion 30 to an end of the body of the housing 4 (Step 501). The bottle neck 34 is positioned within the opening 31 of the top portion 28 such that the flange 44 abuts an inner portion of the top portion 28 (Step 502). The top portion 28 is heat sealed to an opposed end of the body of the housing 4 (Step 503). The container 2 is then moved, by compression, to the first collapsed configuration as shown in Step 504. The container 2 is retained within the first collapsed configuration using a fastener 62 in the form of a strap which is configured to extend between the first and second ends of the container 2 and to prevent unintentional movement of the first end away from the second end.

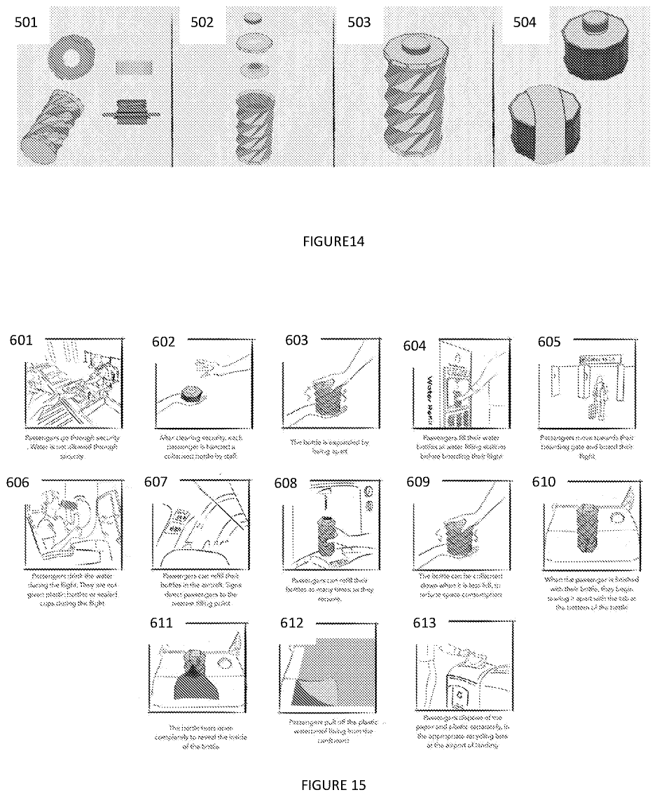

FIG. 15 demonstrates the container of the present invention in use during a flight. As passengers go through security at an airport, all fluids (including water) must be discarded (Step 601). After passing through security, each passenger is handed a container 2 in the first collapsed configuration (Step 602) by for example a member of staff. The passenger then moves the container 2 to the second expanded configuration (Step 603) and fills the container 2 with water at for example filling stations prior to boarding the flight (Step 604). Passengers then board their flight (Step 605). During the flight, the passengers drink water from the container 2 and are not handed the conventional plastic water bottles or cups (Step 606). Passengers are able to refill the bottles on a flight (Steps 607 and 608) as many times as required. Passengers may choose to only partially fill the container 2. As such, the length of the container 2 may be adjusted (between the first collapsed and second expanded configuration) accordingly (Step 609). When the passenger has finished with the container 2, the container 2 may be opened (Step 610). In the illustrated embodiment, the container 2 comprises a tear off portion (this may comprise a line of weakness in the form of for example perforations, or a tear off portion provided by a tab) located at or adjacent the base of the container 2. The container 2 opens fully to reveal the inner surface of the container 2 (Step 611). In the illustrated embodiment, the container 2 comprises an inner waterproof lining (for example inner plastic lining) 64. The passenger can remove this lining (Step 612) and recycle the paper material and plastic material separately at the airport (Step 613).

1. A collapsible, disposable food or beverage container comprising:
a housing comprising:
a first end comprising a top portion defining an outlet;
an opposed second end comprising a base portion; and
side portions extending between the first and second ends,
in which a cavity for receiving a food or beverage is defined between the first end, second end and side portions of the housing, and in which the cavity is in fluid communication with the outlet, and
in which a longitudinal axis is defined between the first and second ends of the housing;
and in which the container is moveable in a direction between:
a first collapsed configuration in which an end or side portion is located at or adjacent a respective opposed end or opposed side portion; and
a second expanded configuration in which the end or side portion is spaced apart from the respective opposed end or opposed side portion of the housing to provide the cavity;
in which the housing is formed entirely from paper material, and in which the entire container is home compostable and/or biodegradable.

2. A collapsible, disposable food or beverage container as claimed in claim 1, in which the container is moveable in a direction extending parallel to the longitudinal axis of the housing, between:
a first collapsed configuration in which the first end is located at or adjacent the second end of the housing; and
a second expanded configuration in which the first end is spaced apart from the second end of the housing to provide the cavity.

3. A collapsible, disposable food or beverage container as claimed in claim 1, in which the container is moveable in a direction extending substantially perpendicular to the longitudinal axis of the housing, between:
a first collapsed configuration in which a first side portion is located at or adjacent a second opposed side portion of the housing; and
a second expanded configuration in which the first side portion is spaced apart from the second opposed side portion of the housing to provide the cavity.

4. A collapsible, disposable food or beverage container as claimed in any preceding claim, in which the container is configured in use to be moveable between the first collapsed configuration and the second expanded configuration by rotation of the first end relative to the second end.

5. A collapsible, disposable food or beverage container as claimed in claim 4, in which the container is configured in use such that the first end is rotatable relative to the second end about the longitudinal axis of the housing.

6. A collapsible, disposable food or beverage container as claimed in any preceding claim, in which the housing comprises a body formed from a single sheet of paper material, in which opposed ends of the single sheet of paper material are affixed together to provide the body of the housing defining the cavity.

7. A collapsible, disposable food or beverage container as claimed in any preceding claim, in which inner surface of the housing is coated with a water resistant coating.

8. A collapsible, disposable food or beverage container as claimed in any preceding claim, further comprising an inner lining located within the cavity of the housing, in which the inner lining is configured to receive food or beverage.

9. A collapsible, disposable food or beverage container as claimed in claim 8, in which the inner lining is composed of biodegradable or recyclable plastic material.

10. A collapsible, disposable food or beverage container as claimed in any preceding claim, in which the housing comprises a body, and the body comprises at least one longitudinal fold extending predominantly between the first and second ends thereof.

11. A collapsible, disposable food or beverage container as claimed in any preceding claim, in which the housing comprises a body, and the body comprises at least one lateral fold extending in a direction substantially perpendicular to the longitudinal axis of the housing.

12. A collapsible, disposable food or beverage container as claimed in either of claims 11 and 12, in which the body comprises at least one diagonal fold extending at an angle to the longitudinal folds and lateral folds.

13. A collapsible, disposable food or beverage container as claimed in any one of claims 12 to 14, in which the container comprises:
a plurality of uniformly spaced longitudinal folds extending predominantly between the first and second ends thereof;
a plurality of uniformly spaced lateral folds extending in a direction substantially parallel to the longitudinal axis of the housing; and
a plurality of uniformly spaced, diagonal folds extending at an angle to the longitudinal folds and lateral folds.

14. A collapsible, disposable food or beverage container as claimed in claim 14, in which at least one of the longitudinal, lateral and diagonal folds is a mountain fold, and in which at least one of the longitudinal, lateral and diagonal folds is a valley fold.

15. A collapsible, disposable food or beverage container as claimed in claim 15, in which the container comprises:
a plurality of uniformly spaced longitudinal folds extending predominantly between the first and second ends thereof;
a plurality of uniformly spaced lateral folds extending in a direction substantially parallel to the longitudinal axis of the housing; and
a plurality of uniformly spaced, diagonal folds extending at an angle to the longitudinal folds and lateral folds,
in which the longitudinal folds are mountain folds, in which the lateral folds are mountain folds, and in which the diagonal folds are valley folds.

16. A collapsible, disposable food or beverage container as claimed in claim 15, in which the container comprises:
a plurality of uniformly spaced longitudinal folds extending predominantly between the first and second ends thereof;
a plurality of uniformly spaced lateral folds extending in a direction substantially parallel to the longitudinal axis of the housing; and
a plurality of uniformly spaced, diagonal folds extending at an angle to the longitudinal folds and lateral folds,
in which the longitudinal folds are mountain folds, in which the lateral folds are valley folds, and in which the diagonal folds are mountain folds.

17. A collapsible, disposable food or beverage container as claimed in any preceding claim, in which the housing has a polygonal transverse cross-section.

18. A collapsible, disposable food or beverage container as claimed in any preceding claim, in which the top portion and/or base portion are attached to the side portions of a body of the housing by heat sealing.

19. A collapsible, disposable food or beverage container as claimed in any preceding claim, in which the top portion comprises a neck portion or spout portion or nozzle portion defining a channel configured in use to be in fluid communication with the cavity of the housing, in which the neck portion or spout portion or nozzle portion is formed from paper pulp material.

20. A collapsible, disposable food or beverage container as claimed in any preceding claim, further comprises a fastener configured in use to prevent unintentional movement of the container from the first collapsed configuration to the second expanded configuration.

21. A collapsible, disposable food or beverage container as claimed in claim 21, in which the fastener is composed of paper material.

22. A collapsible, disposable food or beverage container as claimed in either of claims 21 and 22, in which the fastener is moveable between a first position in which the fastener is configured to retain the container in the first collapsed position, and a second position in which the fastener is secured to at least a portion of the housing and configured in use to enable the user to utilise the fastener for transportation of the container.

23. A method for the manufacture of a collapsible, disposable food or beverage container, comprising:
obtaining a mould configured to provide housing having predetermined shape, dimensions and one or more lines of weaknesses;
obtaining paper material and positioning over the mould;
applying a force to compress the paper material onto the mould to provide resultant housing having the predetermined shape, dimensions and one or more lines of weaknesses.

24. A method as claimed in claim 24, in which a single sheet of paper material is used to form a body of the housing.

25. A method as claimed in either of claims 24 and 25, in which the mould has one or more ridges and/or indentations at predetermined locations.

26. A method as claimed in any one of claims 24 to 26, further comprising coating an inner surface of the paper material with a water resistant coating prior to positioning over the mould.

27. A method as claimed in any one of claims 24 to 27, further comprising securing opposed ends of the paper material to define a tubular shaped body of the housing prior to positioning the paper material over the mould.

28. A method as claimed in any one of claims 24 to 28, further comprising attaching a top portion and a base portion to opposed ends of a body of the housing.

29. A method as claimed in any one of claims 24 to 29, further comprising attaching a bottle neck to the top portion of the housing.
